(19) United States
(12) Patent Application Publication
(10) Pub. No.: US 2023/0231231 A1
(43) Pub. Date: Jul. 20, 2023

(54) A HEAT-RESISTANT BATTERY SEPARATORS AND RELATED BATTERIES AND METHODS

(71) Applicant: Ceigard, LLC, Charlotte, NC (US)

(72) Inventors: Stefan Reinartz, Waxhaw, NC (US); James Rapley, Concord, NC (US); Daniel R. Alexander, Matthews, NC (US)

(21) Appl. No.: 18/007,745

(22) PCT Filed: Jun. 4, 2021
(86) PCT No.: PCT/US2021/035848

§ 371 Date: Dec. 2, 2022

Related U.S. Application Data
(60) Provisional application No. 63/034,413, filed on Jun. 4, 2020.

(51) Int. Cl. H01M 10/658; H01M 50/423; H01M 50/434; H01M 50/457; H01M 50/489

(52) U.S. Cl. CPC H01M 10/658; H01M 50/423; H01M 50/434; H01M 50/457; H01M 50/489

(57) ABSTRACT

Disclosed herein is a battery separator comprising two porous or microporous layers and a heat-resistant layer between the two porous or microporous layers. The heat-resistant layer may be a ceramic layer or a layer containing a high melt integrity polymer. In some embodiments, the battery separator may further comprise one or more adhesive layers between the two porous or microporous layers. The resulting battery separator may be safer, have more integrity, and/or have shutdown function.

### CROSS REFERENCE TO RELATED APPLICATIONS

This application is a 371 U.S. application claiming priority to PCT/US2021/035848, filed Jun. 4, 2021, which claims priority to U.S. Provisional Patent Application Ser. No. 63/034,413, filed Jun. 4, 2020, which is hereby fully incorporated by reference herein.

### FIELD

This application is directed to improved battery separators having, among other things, an internal heat-resistant layer and an optional internal adhesive layer.

### BACKGROUND

Battery separators comprising heat-resistant coatings such as ceramic coatings are known to provide protection in case of thermal runaway in a battery such as a lithium-ion battery. See, for example, U.S. Pat. No. 6,432,586 (now U.S. Pat. RE47,520), which is assigned to Celgard LLC and is incorporated by reference herein in its entirety.

An example of an optimal operating temperature for a lithium ion battery may be, in some cases, from 20° C. to about 60° C. Above these temperatures, parts of the battery, e.g., the electrolyte or electrodes, may begin to break down. Above temperatures ranging from about 130° C. to about 160° C., a polyolefin separator may begin to melt and eventually decompose. During thermal runaway, temperatures may reach 300° C. or more. At these temperatures, electrodes, electrolyte, and a typical polyolefin separator may experience significant decomposition.

In cases where a ceramic coating layer is present, the coating provides separation between the electrodes even at high temperatures like those experienced during thermal runaway. However, a ceramic coating may cause the separator to curl if not applied on both sides, which increases cost.

U.S. Pat. No. 6,432,586 (now U.S. Pat. RE47,520) discloses a battery separator with an internal ceramic layer, but the adhesion of the ceramic layer to adjacent layers may not be optimal without an adhesive layer. Weak adhesion could affect the integrity of the separator. In addition, the afore-described separator in U.S. Pat. No. 6,432,586 (now U.S. Pat. RE47,520) may not have shutdown unless the microporous layers themselves shutdown, e.g., if they have a trilayer structure.

Thus, a heat-resistant separator with greater integrity is desirable. A heat-resistant separator with greater integrity and shutdown is also desirable.

### SUMMARY

The details of one or more embodiments are set forth in the description hereinafter. Other features, objects, and advantages will be apparent from the description and from the claims. In accordance with at least select embodiments, the present disclosure or invention may address the above issues or needs. In accordance with at least certain embodiments, aspects, or objects, the present disclosure or invention may provide an improved separator and/or battery utilizing said separator, which overcomes the aforementioned problems. For instance, the present disclosure or invention provides an improved heat-resistant battery separator, which may contain an internal heat-resistant layer, and in some instances, an adhesive. The separator has excellent heat-resistance and integrity. In some embodiments, the heat-resistant separator also shuts down. Additionally, when used in a secondary batter such as a lithium ion battery, a safer battery results due to the improved heat resistance of the separator. In accordance with other embodiments, aspects, or objects, the present disclosure or invention may provide an improved method for making a heat-resistant separator, especially a heat-resistant separator with an internal heat-resistant layer.

In one aspect, a heat resistant battery separator comprising (1) two microporous layers, (2) a heat-resistant layer between the two microporous layers, and (3) an optional adhesive layer between the microporous layers. In some preferred embodiments, the battery separator may be a thin battery separator. A thin battery separator may have a thickness of 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, or 5 nm or less. In some embodiments, the heat-resistant separator may be symmetric about an axis running parallel to each of the layers of the separator. In some embodiments, the heat-resistant separator shuts down.

The microporous layers of the heat-resistant battery separator may, in some preferred embodiments, be thin. For example, the two microporous layers may each independently of one another have a thickness of 10 nm or less, 9 nm or less, 8 nm or less, 7 nm or less, 6 nm or less, 5 nm or less, 4 nm or less, 3 nm or less, 2 nm or less, or 1 nm or less.

The heat-resistant layer of the heat-resistant battery separator may be at least one selected from (1) a ceramic layer, (2) a layer comprising, consisting of, or consisting essentially of high temperature melt integrity material, (3) a layer comprising a high temperature melt integrity material and a ceramic material, and (4) combinations of layers (1), (2), and (3). A ceramic layer may be a layer comprising 80% or more ceramic or nano-ceramic, 85% or more ceramic or nano-ceramic, 90% or more ceramic or nano-ceramic, 95% or more ceramic or nano-ceramic, 98% or more ceramic or nano-ceramic, or 99% or more ceramic or nano-ceramic. Layer (3) may be a layer that comprises, consists of, or consists essentially of a high temperature melt integrity material and a ceramic. The combination of layers (4) may comprise, consist of, or consist essentially of any combination of at least two selected from a ceramic layer, a layer comprising, consisting of, or consisting essentially of a high temperature melt integrity material, and a layer comprising, consisting of, or consisting essentially of a high temperature melt integrity material and a ceramic or nano-ceramic. In some embodiments, the heat-resistant layer may be porous, and in some embodiments, it may be non-porous.

In embodiments where an adhesive layer is present, one adhesive layer or two or more adhesive layers may be present. The adhesive layer may be present between the heat-resistant layer and at least one of the two microporous layers. Where there are two or more adhesive layers, the adhesive layers may be the same or different. In some embodiments, where there are two or more adhesive layers, the adhesive layers may be adjacent to one another or not. In some embodiments where there are two or more adhesive layers, the adhesive layers may be made of the same or different materials. In some preferred embodiments, the adhesive layers may be thin. For example, they may have a thickness of 2 nm or less, 1.5 nm or less, 1 nm or less, or 0.5 nm or less.

The adhesive layer may comprise, consist of, or consist essentially of a polymer. The polymer may be, in some instances, selected from an acrylic polymer, a PVDF polymer, and combinations thereof.

In another aspect, one preferred embodiments of the heat-resistant separator described herein may comprise (1) two microporous layers, (2) a heat-resistant layer, and (3) an optional adhesive layer between the two microporous layers. In this embodiment, there may be no adhesive layer. Further, the heat-resistant layer comprises, consists of, or consists essentially of a high melt integrity material. Additionally, in this embodiment, a surface of at least one of the two microporous layers comprises a functional group that increases adhesion between that surface of one of the two microporous layer and a surface of the heat-resistant layer. Sometimes, both of the two microporous layers comprises functional group that increases adhesion between that surface and a surface of the heat-resistant layer. The high-melt-integrity (HMI) material may comprise, consist of, or consist essentially of an aramid, a polyimide, and a polyamide imide. Sometimes, the HMI material may be an aramid and the functional group may be an anhydride.

In another aspect, an improved battery comprising at least one heat-resistant battery separator as described herein is described. The improved battery may be safer due to the heat-resistance provided by the separator and/or the shutdown capability offered by the separator. The battery separator described herein may also be used in a capacitor.

Other uses of the product described herein may also be as a textile material, filter material. For example, a textile material for performance garments or personal protective equipment may be envisioned.

### DESCRIPTION OF THE DRAWINGS

FIG. 1 shows schematic drawings of some embodiments described herein.

FIG. 2 shows schematic drawings of some embodiments described herein.

FIG. 3 shows schematic drawings of some embodiments described herein.

FIG. 4 shows schematic drawings of some embodiments described herein.

FIG. 5 shows schematic drawings of some embodiments described herein.

### DETAILED DESCRIPTION

In accordance with at least select embodiments, the present disclosure or invention may address the above issues or needs. In accordance with at least certain objects, aspects, or embodiments, the present disclosure or invention may provide an improved separator and/or battery which overcomes the aforementioned problems, for instance by providing batteries with separators that have improved heat resistance and integrity. Some separators may have improved heat resistance, integrity, and exhibit shutdown.

(A) Heat-Resistant Battery Separator

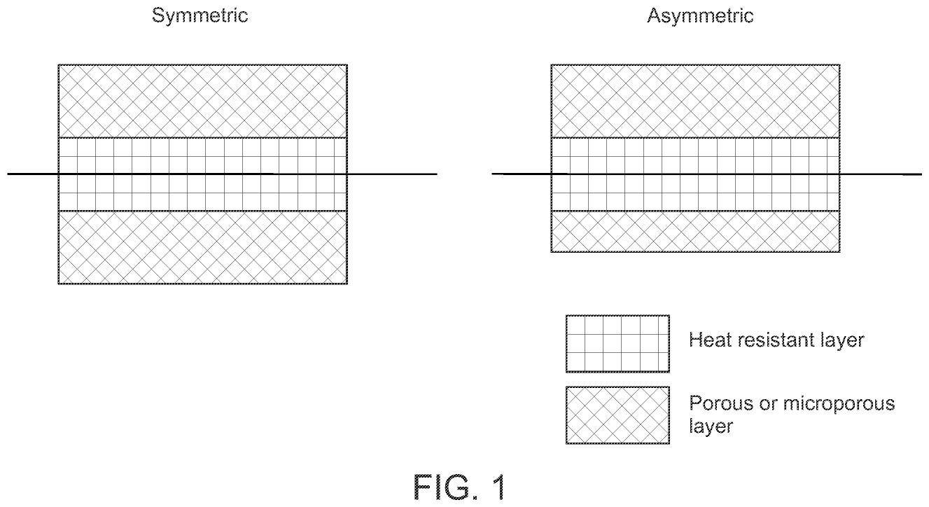

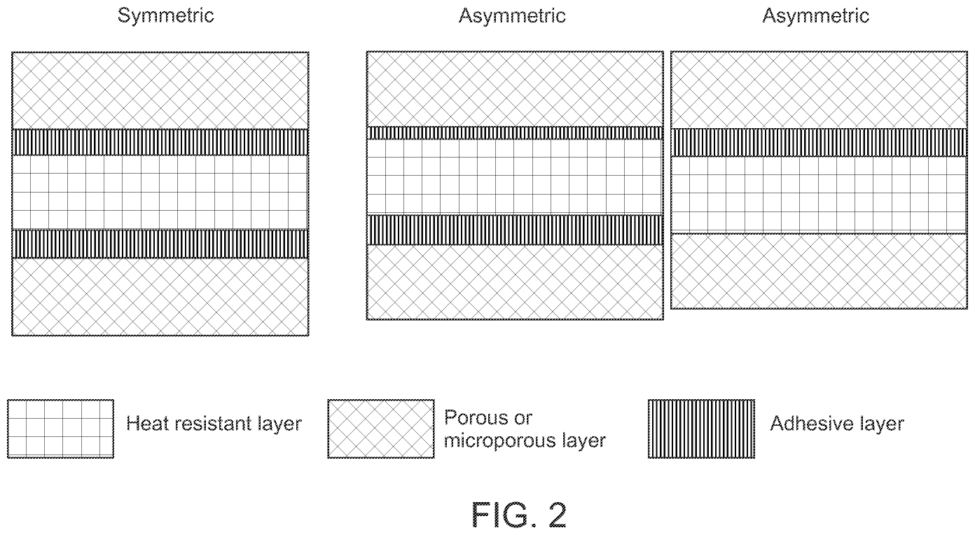

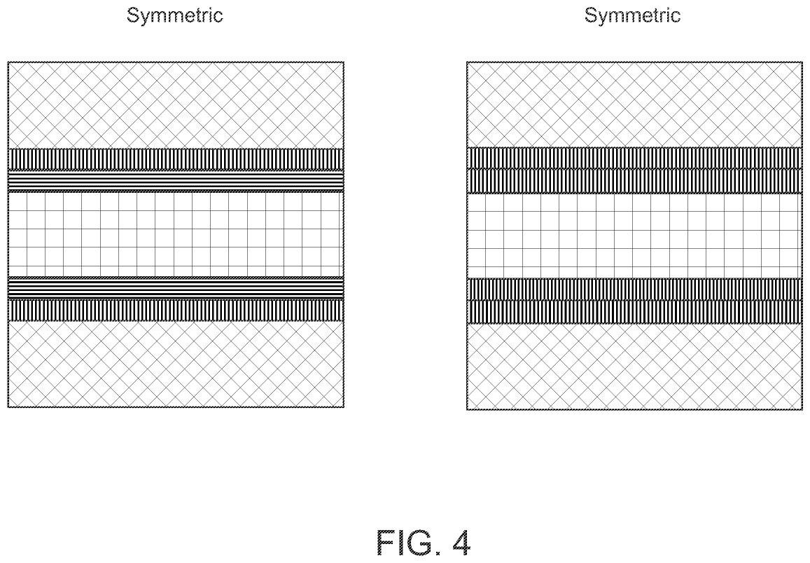

One embodiment of a heat-resistant battery separator as described herein may comprise, consist of, or consist essentially of (1) two porous or microporous layers, (2) a heat-resistant layer between the two porous or microporous layers, and (3) an optional adhesive that is also between the two porous or microporous layers. When the adhesive layer is present, one or more, two or more, three or more, or four or more adhesive layers may be present. FIG. 1 shows exemplary embodiments where no adhesive is present. FIGS. 2-4 show exemplary embodiments where an adhesive is present. Sometimes, at least one (sometimes two or more) adhesive layer may be provided between the heat-resistant layer and one of the two microporous layers. In some embodiments, at least one (sometimes two or more) adhesive layer may be provided between the heat-resistant layer and each of the two microporous layers. In some embodiments, particularly where two or more adhesive layers are used, at least two of the adhesive layers may be adjacent to each other. FIG. 4 shows an embodiment where two different adhesive layers are used (left) and where the same adhesive layer is used (right).

In another embodiment, a heat-resistant battery separator as described herein may comprise, consist of, or consist essentially of (1) two porous or microporous layers and (2) a heat-resistant layer between the two porous or microporous layers. In this embodiment, the heat-resistant layer comprises, consists of, or consists essentially of a high melt integrity material, and a surface of at least one of the two porous or microporous layers comprises a functional group that increases adhesion between that surface and a surface of the heat-resistant layer. In some embodiment, a surface of both of the two porous or microporous layers comprise a functional group that increases adhesion between that surface and a surface of the heat-resistant layer.

The thickness of the heat-resistant battery separator described herein is not limited and may be up to 50 microns thick, up to 40 microns thick, up to 30 microns thick, up to 20 microns thick, up to 10 microns thick, or up to 5 microns thick. In some preferred embodiments, the heat-resistant battery separator described herein may be thin. For example, the thickness may be 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, or 5 nm or less.

The heat-resistant battery separator described herein may be symmetric about an axis running parallel to the layers of the separator. For example, examples of symmetric and asymmetric are found in FIG. 1. Without wishing to be bound by any particular theory, it is believed that a symmetric separator may be preferred for improved integrity because it is less likely to curl. Asymmetries in a battery separator may cause curl.

In some embodiments, the heat-resistant separator described herein may exhibit shutdown. For example, one of the porous or microporous layers may be capable of shutdown or the heat-resistant layer or a combination of the heat-resistant layer and the adhesive layers may be capable of shutdown.

(1) Porous or Microporous Layers

The porous or microporous layers described herein are not so limited. In some preferred embodiments, the porous or microporous layers may be porous or microporous layers made ones by a dry-stretch process such as the Celgard® dry-stretch process. In some embodiments, porous or microporous layers may be ones made by another dry process such as BNOPP where a beta-nucleating agent is used. In further embodiments, the porous or microporous layers may be one made by a wet process that utilizes a solvent or oil. In some embodiments, the porous or microporous layer may be a woven or non-woven layer.

The pore size of the porous or microporous layer is not so limited. In some preferred embodiments, the pore size may be from 0.01 to 1.0 microns. In some embodiments, the pore size may be greater than 1.0 micron.

The thickness of the porous or microporous layer is also not so limited and may range from about 1 micron to about 20 microns. In some preferred embodiments, the porous or microporous layers may be thin. For example, the may have a thickness of 10 microns or less, 9 microns or less, 8 microns or less, 7 microns or less, 6 microns or less, 5 microns or less, 4 microns or less, 3 microns or less, 2 microns or less, or 1 micron or less. In some instances the thicknesses of the two porous or microporous layers of the separator may be the same and in some instances they may have different thicknesses.

In some embodiments, the porous or microporous layer may be a monolayer, bilayer, trilayer or multilayer. For example, it may be a porous or microporous multilayer membrane as described in WO 2018/089748, which is assigned to Celgard LLC and incorporated by reference herein in its entirety. Further, the porous or microporous layer may be a porous or microporous trilayer as described in U.S. Pat. No. 5,691,077, which is incorporated by reference herein in its entirety. When a shutdown trilayer is used, the battery separator will also have shutdown capability.

The material of the porous or microporous layer is not so limited and may include any thermoplastic material. In some embodiments, the microporous layer may comprise, consist of, or consist essentially of one or more polyolefins. For example, a homopolymer, copolymer, or terpolymer of polyethylene, polypropylene, or combinations thereof may be used. The material may be a single resin or a resin blend. The material may also include additives.

In some embodiments, additives that increase the adhesion of the porous or microporous layers to the heat-resistant layer may be added. The additive may be added to a monolayer or to one or more layers of a bilayer, trilayer, or multilayer embodiment. When added to one or more layers of a bilayer, trilayer or multilayer embodiment, the additive is preferably added to a material of an external or layer whose surface will be in contact with the heat-resistant layer. In some embodiments, the additive is a material comprising anhydride functional groups. For example, a graft polymer comprising anhydride functional groups may be used. For example, a maleic anhydride grafted polypropylene or polyethylene polymer may be used. In embodiments where such an additive is used in the porous or microporous layers, a heat resistant layer comprising, consisting of, or consisting essentially of an aramid may be used.

(2) Heat-Resistant Layer

The material of the heat-resistant layer is not so limited, and may be any material that can withstand temperatures above 160° C., above 170° C., above 180° C., above 190° C., above 200° C., above 210° C., above 220° C., above 230° C., above 240° C., above 250° C., above 260° C., above 270° C., above 280° C., above 290° C., or above 300° C. This means that the material does not deform, melt, decompose or disintegrate at and/or above these temperatures.

In some embodiments, the heat-resistant layer may be a ceramic layer containing 70% or more, 75% or more, 80% or more, 85% or more, 90% or more, 95% or more, 96% or more, 97% or more, 98% or more, or 99% or more of a ceramic. The ceramic layer may also include a binder material. An exemplary ceramic layer is disclosed in U.S. Pat. No. 6,432,586 (now RE47,520), which is assigned to Celgard LLC and incorporated by reference herein in its entirety.

In some embodiments, the heat-resistant layer may comprise, consist of, or consist essentially of a high melt integrity polymer. A high melt integrity polymer does not lose physical integrity until temperatures above 160° C., above 170° C., above 180° C., above 190° C., above 200° C., above 210° C., above 220° C., above 230° C., above 240° C., above 250° C., above 260° C., above 270° C., above 280° C., above 290° C., or above 300° C. are reached.

Examples of high-melt integrity polymers are not so limited and may include any polymer with stability at or above 160° C. This may include, but is not limited to, aramids, polyamideimides, polyamides, polyketones, polysulfone derivatives, fluoropolymers, polyetherimides, polyphenylene sulfides, syndiotactic polystyrene, polybenzimidazoles, PVC, PVF, syndiotactic PMMA, Nylon, isotactic polystyrene, and combinations thereof. Cross-linked polyolefins such as cross-linked PP or PE may also be used. Photoinitiated polymers may also be used.

In some examples, the heat-resistant layer may comprise, consist of, or consist essentially of a ceramic and a high-melt integrity polymer.

In some embodiments, the heat-resistant layer may be porous or microporous. In some embodiments, the heat-resistant layer may be nonporous, but ionically conductive. In some embodiments, the heat-resistant layer may be a woven or non-woven layer (staple, melt-blown, spunlaid, flashspun, air-laid, etc.).

In some embodiments, the heat-resistant layer may be a single layer, but in other embodiments, the heat-resistant layer may include two or more, three or more, or four or more layers. The layers may be made of the same or different combinations of the above-mentioned materials, including ceramics and high-melt integrity polymers.

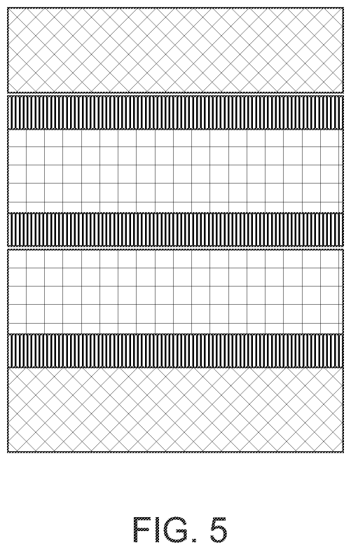

In some embodiments, there may be more than one heat-resistant layers between the two porous or microporous layers. An example of this is shown in FIG. 5.

(3) Adhesive Layers

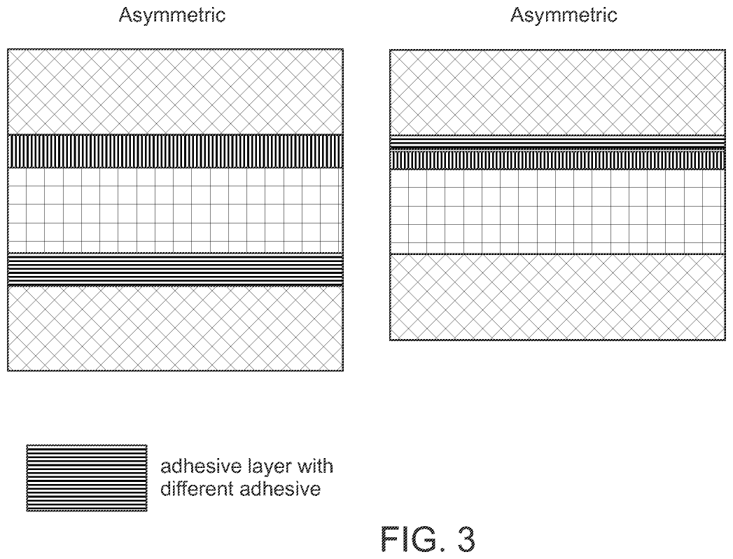

The adhesive layers are not so limited. In some embodiments, one adhesive layer may be used and placed between the heat-resistant layer and one of the porous or microporous layers. See FIG. 2 on the far-right. In some embodiments, two adhesive layers may be used and placed either between the heat-resistant layer and one of the porous or microporous layers or between the heat-resistant layer and each of the porous or microporous layers. See FIG. 3. In some embodiments, three adhesive layers may be used. Here, all three adhesive layers may be placed between the heat-resistant layer and one of the porous or microporous layers or two adhesive layers may be placed between the heat-resistant layer and one of the porous or microporous layers and the other adhesive layer may be placed between the heat-resistant layer and the other porous or microporous layer. In some embodiments, four or more adhesive layers may be used. Some exemplary embodiments where four adhesive layers are used are shown in FIG. 4. In some embodiments where four or more adhesive layers are used, with at least two on either side of the heat-resistant layer, an adhesive layer may be formed on each side of the heat-resistant layer and on at least one surface of each porous or microporous layer. Then, the adhesive layers on each side of the resistant layer are each joined with an adhesive layer on one of the porous or microporous layer using heat, pressure, or a combination of both.

In some embodiments, the adhesive layer may have a thickness of 10 microns or less, 9 microns or less, 8 microns or less, 7 microns or less, 6 microns or less, 5 microns or less, 4 microns or less, 3 microns or less, 2 microns or less, 1 micron or less, or 500 nm or less. In some embodiments, the adhesive layer is thin or has a thickness of 2 microns or less, 1 micron or less, 500 nm or less, or 250 nm or less.

In some embodiments, the adhesive layer may fully or partially extend into or fill or coat or impregnate the pores of the porous or microporous layer or into the pores of the heat-resistant layer if a porous heat-resistant layer is used. In such embodiments, the strength of the battery separator may be improved.

The material of the adhesive layer is not so limited. For example, the layer may comprise, consist of, or consist essentially of any material that adheres both to the underlying layer it is formed on (porous or microporous layer or heat-resistant layer). The adhesive layer must also be able to form a separator with integrity where the separator comprises at least two porous or microporous layers and a heat-resistant layer between them. The adhesive layers may be used to provide a better bond between the heat-resistant layers and the porous or microporous layers. Any adhesive material may be used so long as the resulting separator has a minimal peel force between the layers. For example, a peel force about equal to the peel force between layers of a commercial trilayer product may be acceptable.

In some embodiments, the adhesive layer may comprise, consist of, or consist essentially of a polymer selected from the following: acrylates; PVDF and copolymers thereof such as PVDF-HFP and PVDF-CTFE; polyethylene (or other polymers having a melting point equal to or less than that of polyethylene); and combinations thereof. In some embodiments, when polyethylene or other polymers having a melting point equal to or less than that of polyethylene are used, the resulting separator may have shutdown.

In addition the above-mentioned polymers, the adhesive layer may comprise ceramics or nano-ceramics. Nano-ceramics are ceramics having an average particle size less than 500 nm, less than 450 nm, less than 400 nm, less than 350 nm, less than 300 nm, less than 250 nm, less than 200 nm, less than 150 nm, or less than 100 nm. In some preferred embodiments, the ceramics or nano-ceramics are added in an amount of less than 50%, less than 40%, less than 30% or less than 20%. In some preferred embodiments, the ceramics or nano-ceramics are added in an amount of 10% or less, 9% or less, 8% or less, 7% or less, 6% or less, 5% or less, 4% or less, 3% or less, 2% or less, or 1% or less.

The adhesive layers may be formed using a solvent-based or aqueous coating solution or slurry. In some preferred embodiments, forming the layer from an aqueous coating solution or slurry may be preferred at least from an environmental perspective. An aqueous coating solution contains 95% or more water, 96% or more water, 97% or more water, 98% or more water, 99% or more water, or 100% water. In preferred embodiments, an aqueous solvent contains no organic solvent, but it may contain some to aid with the dispersability or solubility.

### EXAMPLES

### Example 1

Two porous or microporous films were formed using a dry-stretch process comprising extrusion, annealing, and stretching. In the extrusion process, a maleic anhydride modified PP was extruded with another homopolymer PP. The porous or microporous films were laminated with a porous aramid film to form a sandwich structure with the aramid film in the middle between the two porous or microporous films. Addition of the maleic anhydride modified PP may improve adhesion between the aramid film and the porous or microporous layers.

### Example 2

Two porous or microporous films were formed using a dry-stretch process comprising extrusion, annealing, and stretching. In the extrusion process, a homopolymer PP was extruded. The porous or microporous films were laminated with a porous aramid film to form a sandwich structure with the aramid film in the middle between the two porous or microporous films.

### Example 3

A first porous or microporous polypropylene layer was coated with a ceramic layer. Next, a PVDF-HFP containing layer was coated on the ceramic layer. Then, a second porous or microporous layer was coated with a PVDF-HFP containing film, and the first and second porous or microporous layers were connected via the PVDF-HFP layers for form a structure of first porous or microporous layer, ceramic layer, PVDF-HFP layer, PVDF-HFP layer, second porous or microporous layer. In this embodiment, the thickness of the two PVDF-HFP layers are equal to the thickness of the ceramic layer, but they may be unequal.

### Example 4

A first porous or microporous layer was coated with an adhesive layer 1, a ceramic layer on top of the adhesive layer 1, and another adhesive layer 2 on top of the ceramic layer. Then, a second porous or microporous layer was coated with an adhesive layer 3. Finally, the first and second porous or microporous layers were joined via the exposed adhesive layers 2 and 3 to form a structure—first porous or microporous layer, adhesive layer 1, ceramic layer, adhesive layer 2, adhesive layer 3, second porous or microporous layer. In this embodiment, adhesive layer 1 may have a thickness equal to that of adhesive layers 2 and 3 combined, but the thickness of adhesive layer 1 may also be greater than or less than that of adhesive layers 2 and 3 combined. A symmetric structure where the adhesive layer 1 may have a thickness equal to that of adhesive layers 2 and 3 is possibly preferred.

### Example 5

Example 5 has the same structure as Example 4 except that at least one of the adhesive layers functions as a shutdown layer. For example, at least one of the adhesive layers comprises PVDF-HFP, Polyethylene beads, and less than 10% of a nano-ceramic such as nano-alumina. The adhesive layer that functions as a shutdown layer may have a thickness of 2 microns.

### Example 6

Example 6 is formed like Example 3 except that the PVDF-HFP layers are formed using an acrylic resin.

### Example 7

Example 7 is formed like Example 5 except an acrylic resin was used instead of PVDF-HFP.

### Example 8

Example 8 is formed like Example 5 except nano-alumina is not used. The embodiment including nano-alumina is possibly preferred.

### Example 9

Example 9 is formed like Example 7 except that nano-alumina is not used. The embodiment including nano-alumina is possibly preferred.

### Example 10

Example 10 was formed like Example 3 except that the second porous or microporous layer was coated with an adhesive layer that also coated or partially coated the pores of the second porous or microporous layer. This may result in a stronger battery separator and the adhesive layer may be able to be formed thinner because some of the coating slurry used to form the adhesive layer gets into and coats the pores of the second porous or microporous layer.

### Example 11

Example 11 is like Example 4 except that one or more of the adhesive layers may be thin or have thicknesses of 500 nm or less. This may be accomplished, in some embodiments, by adding nano-Alumina in an amount of 10% or less to the adhesive layers.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” may be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

1. A heat-resistant battery separator comprising:
two microporous layers;
a heat-resistant layer between the microporous layers; and
an optional adhesive layer between the microporous layers.

2. The heat-resistant battery separator of claim 1, wherein at least one of
the battery separator is thin and has a thickness of 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, or 5 nm or less; and
the two microporous layers are thin and each independently have a thickness of 10 nm or less, 9 nm or less, 8 nm or less, 7 nm or less, 6 nm or less, 5 nm or less, 4 nm or less, 3 nm or less, 2 nm or less, or 1 nm or less.

3. (canceled)

4. The heat-resistant battery separator of claim 1, wherein at least one of
the heat-resistant layer is at least one selected from the group consisting of a ceramic layer, a layer comprising, consisting of, or consisting essentially of high temperature melt integrity material, a layer comprising a high temperature melt integrity material and a ceramic material, and combinations thereof;
the heat-resistant layer is ceramic layer comprising 80% or more ceramic, 85% or more ceramic, 90% or more ceramic, 95% or more ceramic, 98% or more ceramic, or 99% or more ceramic;
the heat-resistant layer is a layer comprising, consisting of, or consisting essentially of a high temperature melt integrity material;
the heat-resistant layer is a layer that comprises, consists of, or consists essentially of a high temperature melt integrity material and a ceramic; and
the heat-resistant layer comprises, consists of, or consists essentially of a combination of at least two selected from a ceramic layer, a layer comprising, consisting of, or consisting essentially of a high temperature melt integrity material, and a layer comprising, consisting of, or consisting essentially of a high temperature melt integrity material and a ceramic.

5. (canceled)

6. (canceled)

7. (canceled)

8. (canceled)

9. The heat-resistant separator of claim 1, wherein the heat-resistant layer is porous.

10. The heat-resistant separator of claim 1, wherein the heat-resistant layer is non-porous.

11. The heat-resistant separator of claim 1, wherein the adhesive layer comprises, consists of, or consists essentially of a polymer and optionally wherein the polymer is at least one selected from an acrylic polymer, a PVDF polymer, and combinations thereof.

12. (canceled)

13. The heat-resistant separator of claim 1, wherein two or more adhesive layers are present and wherein optionally at least one of
the adhesive layers are thin having a thickness of 2 microns or less, 1.5 microns or less, 1 micron or less, or 0.5 microns or less; and
the adhesive layer comprises, consists of, or consists essentially of a polymer and a ceramic, which may be a nano-ceramic.

14. The heat-resistant separator of claim 13, wherein at least one of the two or more adhesive layers is present between the heat-resistant layer and each of the porous layers.

15. The heat-resistant separator of claim 13, wherein two of the two or more adhesive layers are adjacent to each other and optionally wherein the adjacent adhesive layers are made of the same or different materials.

16. (canceled)

17. The heat-resistant separator of claim 1, wherein the adhesive layers are thin having a thickness of 2 microns or less, 1.5 microns or less, 1 micron or less, or 0.5 microns or less.

18. The heat-resistant separator of claim 1, wherein the adhesive layer comprises, consists of, or consists essentially of a polymer and a ceramic, which may be a nano-ceramic.

19. The heat-resistant separator of claim 1, wherein the structure of the separator is symmetric about an axis running parallel to each of the layers of the separator.

20. The heat-resistant separator of claim 1, wherein the separator also shuts down.

21. An improved battery comprising the heat-resistant battery separator of any one of claim 1.

22. A heat-resistant battery separator comprising two microporous layers and a heat-resistant layer between the microporous layers, wherein
the heat-resistant layer comprises, consists of, or consists essentially of a high melt integrity material, and
a surface of at least one of the two microporous layers comprises a functional group that increases adhesion between that surface of one of the two microporous layer and a surface of the heat-resistant layer.

23. The heat-resistant battery separator of claim 22, wherein at least one of
the high melt integrity material comprises, consists of, or consists essentially of at least one selected from the group consisting of an aramid, a polyimide, and a polyamide imide;
the functional group is an anhydride; and
the high melt integrity material comprises, consists of, or consists essentially of an aramid.

24. (canceled)

25. (canceled)

26. The heat-resistant battery separator of claim 22, wherein at least one of
a surface of both of the two microporous layers comprises functional group that increases adhesion between that surface and a surface of the heat-resistant layer;
the functional group is an anhydride; and
the high melt integrity material comprises, consists of, or consists essentially of an aramid.

27. (canceled)

28. (canceled)

29. (canceled)
